(19) United States
(12) Patent Application Publication
(10) Pub. No.: US 2007/0062989 A1
(43) Pub. Date: Mar. 22, 2007

(54) Sling type baby holding carrier

(75) Inventors: Kenzou Kassai, Osaka (JP); Miyuki Nishikura, Hyogo (JP); Emiko Kaya, Osaka (JP)

Correspondence Address: DITTHAVONG MORI & STEINER, P.C., 918 Prince St., Alexandria, VA, 22314, US

(73) Assignee: Aprica Ikujikenkyukai Aprica Kassai Kabushikikaisha, Osaka (JP)

(21) Appl. No.: 11/524,848

(22) Filed: Sep. 21, 2006

(30) Foreign Application Priority Data
Sep. 21, 2005 (JP) 2005-274392
Dec. 28, 2005 (JP) 2005-378340

(51) Int. Cl. A61G 1/00; A61G 5/00

(52) U.S. Cl. 224/158

(57) ABSTRACT

A sling type baby holding carrier comprises a cloth sling body that can be crossed, a crotch support part fixed to the inner surface of the sling body so as to support the crotch of a baby, an abdomen support part continuously extending from the crotch support part so as to support the abdomen of the baby, and a connecting member for connecting the sling body to the abdomen support part.

### BACKGROUND OF THE INVENTION

1. Field of the Invention

The present invention relates to a sling type baby holding carrier to hold a baby.

2. Description of the Background Art

A sling type baby holding carrier is disclosed in Japanese Unexamined Patent Publication No. 2005-52584, Japanese Unexamined Patent Publication No. 2004-222828, and Japanese Unexamined Patent Publication No. 2003-47542, for example.

The sling type baby holding carrier is for holding a baby by crossing a piece of cloth sling. Since the baby is gently enveloped in the cloth sling in appearance, a mother or a father is willing to use it recently.

Although a conventional sling type baby holding carrier looks gentle, a baby held by it does not always feel comfortable.

First, since the back of the baby is enveloped and supported by the soft cloth, the back of the baby could be bent uncomfortably. Since the newborn baby breathes from the abdomen, if the back is largely bent, the abdominal breathing could be hindered.

Secondly, since the body of the baby is only enveloped and supported by the cloth sling from beneath, when the baby moves actively in the sling, the body of the baby could slip off the sling unexpectedly.

Thirdly, since the sling type baby holding carrier is only supported on the shoulder of a user in a crossed state, it is difficult to hold the baby in an appropriate posture in the sling.

Fourthly, since the conventional sling type baby holding carrier is provided only by connecting one end part and the other end part of a cloth sling body on the shoulder of the user, the connection could be disconnected unexpectedly.

A sling type baby holding carrier that can solve the above problems has been demanded. In addition, a sling type baby holding carrier with which a user can hold the baby with a sense of security has been demanded.

### SUMMARY OF THE INVENTION

It is an object of the present invention to provide a sling type baby holding carrier that is superior in safety.

It is another object of the present invention to provide a sling type baby holding carrier that can appropriately maintain the posture of a baby.

A sling type baby holding carrier according to the present invention comprises a cloth sling body that can be crossed, a crotch support part fixed to the inner surface of the sling body so as to support the crotch of a baby, an abdomen support part continuously extending from the crotch support part so as to support the abdomen of the baby, and a connecting member for connecting the sling body to the abdomen support part.

According to the sling type baby holding carrier having the above constitution, since the body of the baby can be stably held on the inner surface of the sling body by the crotch support part, the abdomen support part and the connecting member, the body of the baby does not slip off unexpectedly.

Preferably, the abdomen support part expands from the boundary with the crotch support part largely. In this case, the connecting member is connected to the largely expending both sides of the abdomen support part. Thus, a fitment and the like used at the connecting point will not come into contact with the thigh of the baby.

Preferably, the sling type baby holding carrier comprises a back support part arranged on the inner surface of the sling body so as to support the back of the baby. The back support part can prevent the back of the baby from being bent uncomfortably. When the sling body is used for holding the baby laterally, since the back support part can maintain the baby almost horizontally, the baby and the parent can be face to face with each other at an appropriate distance. Thus, the bond between parent and child can be deepened.

According to one embodiment, a back support pad is contained in the back support part. The back support pad may be fixed to the back support part or it may be contained in the back support part so as to be removable. When the back support pad is removable, the sling body can be folded compactly.

Preferably, a buckle member for detachably connecting one end part to the other end part of the sling body to be crossed is mounted on each end. When the one end part and the other end part of the sling body can be surely connected by the buckle member, the connection can be prevented from being disconnected unexpectedly.

According to a preferable embodiment, a belt retaining the buckle member is mounted on each of one end part and the other end part of the sling body to be crossed. In addition, a reinforcing strap extending so as to connect the belt at one end part to the belt at the other end part is sewn on the inner surface of the sling body. The reinforcing strap for connecting the belt at one end part to the belt at the other end part can prevent the sling body from ripping.

According to a further preferable embodiment, the sling type baby holding carrier comprises a back support pad held on the inner surface of the sling body so as to support the back of the baby and the back support pad has a bending line extending in a width direction and can be bent along the bending line. In this case, the bending line of the back support pad is positioned so as to overlap on the reinforcing strap. When the back support pad can be bent along the bending line, the sling type baby holding carrier can be folded compactly even with the back support pad contained. Since the bending line of the back support pad is supported by the reinforcing strap from beneath when the baby is held, the back support pad is not largely bent, so that the back of the baby can be held in appropriate posture.

According to one embodiment, the reinforcing strap comprises a first reinforcing strap and a second reinforcing strap extending with a space in a vertical direction. In this case, in order to improve the ventilation characteristic of the sling type baby holding carrier, a part positioned between the first reinforcing strap and the second reinforcing strap in the sling body is made of a mesh material. Even when the mesh material has small strength, since it is provided only at a region sandwiched between the first reinforcing strap and the second reinforcing strap, the strength of the sling type baby holding carrier is not lost as a whole. In addition, a plurality of ventilation windows may be provided in the sling body in order to improve the ventilation characteristics with the consideration for its strength. For example, a mesh material is attached to the ventilation window. The ventilation windows are formed so as to be positioned at both sides of the head of the baby or both sides of the body of the baby.

Preferably, a belt retaining the buckle member is mounted on each of one end part and the other end part of the sling body to be crossed, and a charm ring through which a part of the sling body is passed is mounted on the one end part. Since the buckle member is not seen from the outside when a part of the sling body is passed through the charm ring, its beauty of outer appearance is improved.

According to a preferable embodiment, the sling type baby holding carrier comprises a head guard part connected to the upper end of the back support part such that it can be bent. For example, when the sling type baby holding carrier is used to hold the baby laterally, the head guard part is bent upward from the upper end of the back support part to guard the top of the head of the baby. When the sling type baby holding carrier is used to hold the baby vertically, the head guard part is folded toward the back surface of the back support part in order to open the space above the head of the baby. Preferably, a head guard pad is contained in the head guard part.

According to a still preferable embodiment, the sling type baby holding carrier further comprises an assistive belt for connecting one end part of the sling body to be crossed to the side part of the back support part or crotch support part that is closer to that end part. The assistive belt allows the back support part to be held stably in the horizontal direction when the sling type baby holding carrier is used for holding the baby laterally.

According to one embodiment, each of the crotch support part and the abdomen support part comprises an elastic material. More specifically, each of the crotch support part and the abdomen support part comprises a pad having restoring force to return to a plane configuration. When the crotch support part and the abdomen support part comprise the elastic material, since the crotch support part and the abdomen support part can be kept in the largely curved three-dimensional configuration when connected by the connecting member, the abdomen of the baby is not pressed.

### BRIEF DESCRIPTION OF THE DRAWINGS

FIG. 1 is a view showing a sling type baby holding carrier in use according to one embodiment of the present invention;

FIG. 2 is a plan view showing an exploded sling type baby holding carrier;

FIG. 3 is a plan view showing a state in which an abdomen support part is folded from a state shown in FIG. 2;

FIG. 4 is a plan view showing a state in which a first belt is folded toward a second belt from a state shown in FIG. 2;

FIG. 5 is a perspective view showing a state in which the first belt and the second belt are connected;

FIG. 6 is a perspective view showing a state in which a part of a sling body is passed through a charm ring;

FIG. 7 is a plan view showing a back support pad;

FIG. 8 is a view showing a sling type baby holding carrier according to another embodiment of the present invention;

FIG. 9 is a view schematically showing the sling type baby holding carrier in use according to another embodiment of the present invention;

FIG. 10 is a perspective view showing a state in which a first belt and a second belt are connected;

FIG. 11 is a view showing a back support pad as another example;

FIG. 12 is a schematic view showing a child restraint member as another example;

FIG. 13 is a schematic view showing a back support pad as another example;

FIG. 14 is a sectional view taken along line 14-14 in FIG. 13;

FIG. 15 is a schematic view showing a back support pad as another example;

FIG. 16 is a schematic view showing a back support pad as another example;

FIG. 17 is a schematic view showing a sling type baby holding carrier having a load supporting reinforcing strap;

FIG. 18 is a schematic view showing a sling type baby holding carrier having a load supporting reinforcing strap as another example;

FIG. 19 is a schematic view showing a sling type baby holding carrier having a load supporting reinforcing strap as still another example;

FIG. 20 is a schematic view showing a sling type baby holding carrier having a load supporting reinforcing strap still another example;

FIG. 21 is a schematic view showing a sling type baby holding carrier having a hood;

FIG. 22 is a schematic view showing a sling type baby holding carrier having a hood as another example;

FIG. 23 is schematic sectional view showing a hood, in which (a) shows its exploded state and (b) shows its folded state;

FIG. 24 is a view schematically showing a sling type baby holding carrier having a hand receiving member;

FIG. 25 is a schematic view showing a mounted state of a sling type baby holding carrier having a connecting member;

FIG. 26 is a view schematically showing a sling type baby holding carrier having a connecting member according to another embodiment;

FIG. 27 is a view showing a sling type baby holding carrier having a connecting member according to another embodiment;

FIG. 28 is a schematic view showing a sling type baby holding carrier having a soundproof member;

FIG. 29 is a view schematically showing a sling type baby holding carrier comprising a head pad having a soundproof member;

FIG. 30 is a sectional view showing a head pad having a soundproof member as another example;

FIG. 31 is a partially perspective view showing a sling type baby holding carrier comprising a removable charm member;

FIG. 32 is a view schematically showing a charm member having a configuration that can be used as a scarf;

FIG. 33 is a perspective view showing a mounted state of a charm member according to another embodiment;

FIG. 34 is a view showing a state in which a charm member is used as a rain cover;

FIG. 35 is a view showing a state in which a charm member is used as a mosquito net;

FIG. 36 is a perspective view showing a shoulder pad of a sling type baby holding carrier;

FIG. 37 is a schematic view showing a sling type baby holding carrier comprising a slit; and

FIG. 38 is a schematic perspective view showing a cylindrical member surrounding the slit.

### DESCRIPTION OF THE PREFERRED EMBODIMENTS

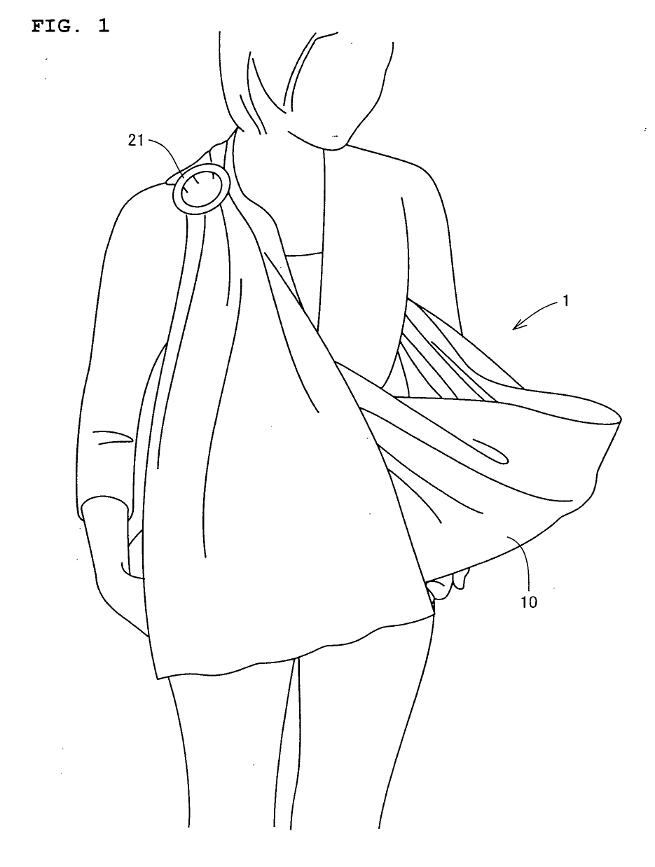

FIG. 1 shows a state in which a sling type baby holding carrier according to one embodiment of the present invention is used for holding a baby laterally. As shown in FIG. 1, the sling type baby holding carrier 1 comprises a cloth sling body 10 that can be crossed. When one end and the other end of the sling body 10 are connected on the shoulder or its vicinity of a user, a part of the sling body 10 is passed through a charm ring 21 that is provided in the vicinity of the connected part.

Although FIG. 1 shows the case where the baby is held laterally, the baby can be held vertically by appropriately changing the connected position of one end and the other end of the sling body 10.

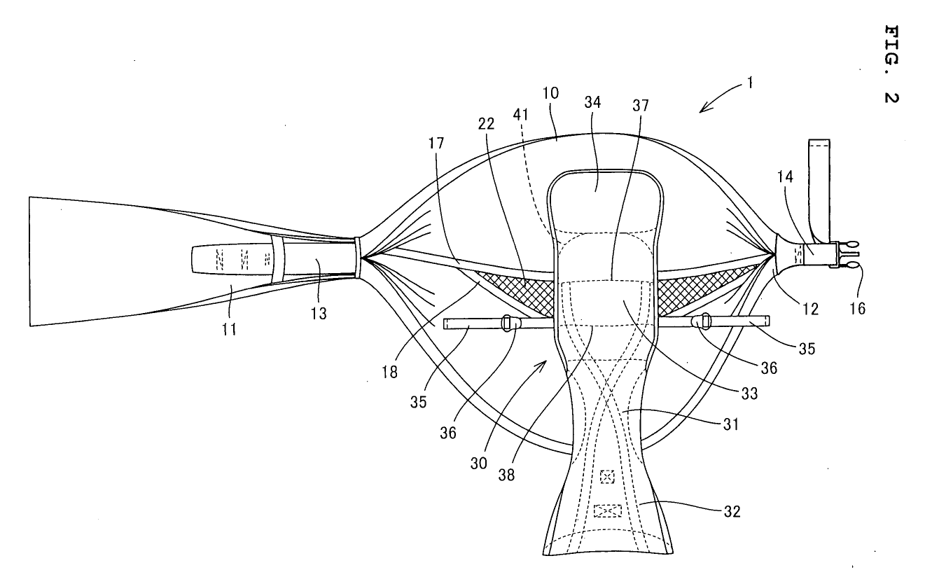

FIG. 2 is a plan view in which the sling type baby holding carrier 1 is exploded and its inner side is shown. As shown in FIG. 2, a baby restraint member 30 to restrain the body of the baby is mounted on the inner surface of the sling body 10. The baby restraint member 30 comprises a crotch support part 31 mounted on and fixed to the inner surface of the sling body 10 so as to support the crotch of the baby, an abdomen support part 32 continuously extending from the crotch part so as to support the abdomen of the baby, a back support part 33 mounted on and fixed to the inner surface of the sling body 10 so as to support the back of the baby, and a head guard part 34 that is bent from the back support part 33 so as to guard the top of the head of the baby.

FIG. 3 shows a state in which the abdomen support part 32 is folded. As shown in FIG. 3, the sling type baby holding carrier 1 comprises a connecting member for connecting the sling body 10 to the abdomen support part 32. More specifically, the connecting member comprises a pair of connecting belts 35 extending from both side edges of the backrest part 33, a pair of connecting hooks 36 mounted on the pair of connecting belts 35, and a pair of connecting rings 39 mounted on the abdomen support part 32. When the baby is held, the body of the baby is restrained by connecting the pair of connecting hooks 36 and the pair of connecting rings 39.

As shown in FIG. 3, a pair of connecting rings 40 is provided apart from the pair of connecting rings 39. This is provided so that the connecting ring to be connected to the connecting hook 36 can be selected according to the size of the baby. When the baby is small, the connecting hook 36 is connected to the connecting ring 39 and when the baby is big, the connecting hook 36 is connected to the connecting ring 40.

The crotch support part 31 and the abdomen support part 32 may contain an elastic material. More specifically, each of the crotch support part 31 and the abdomen support part 32 comprises a pad having restoring force by which it tries to return to its original planar shape. According to the elastic crotch support part 31 and abdomen support part 32, when the abdomen support part 32 and the sling body 10 are connected with the connecting members 35, 36 and 39, since the crotch support part 31 and the abdomen support part 32 maintain largely curved three-dimensional shapes, the abdomen of the baby is not pressed.

In order to keep the shape of the head guard part 34 surely, it preferably contains a head guard pad. Similarly, in order to appropriately hold the back of the baby, the back support part 33 contains a back support pad 41 (refer to FIG. 7). In order to fold the sling type baby holding carrier 1 compactly, the back support pad 41 is preferably removed from the back support part 33.

When the sling type baby holding carrier 1 is used for holding the baby laterally, that is, when the back support part 33 is used in a horizontal state, the head guard part 34 is bent upward at the upper end of the back support part 33 to cover the top of the head of the baby. When the sling type baby holding carrier 1 is used for holding the baby vertically, that is, when the back support part 33 is used in the vertically direction, the head guard part 34 is folded toward the back surface of the back support part 33 to open the space above the head of the baby.

As shown in FIG. 7, the back support pad 41 preferably has many ventilation holes 42. In addition, the back support pad 41 has a first bending line 37 and a second bending line 38 extending in the width direction so that it can be bent along the bending lines 37 and 38. When the back support pad 41 has the bending lines and can be bent along the lines, the sling type baby holding carrier 1 can be folded compactly with the back support pad 41 contained.

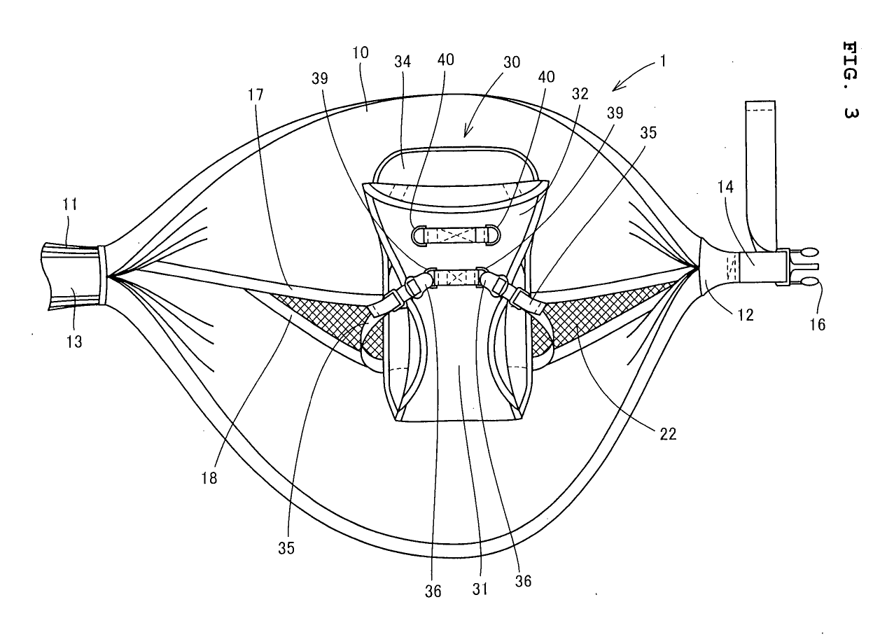

As shown in FIG. 2, a first belt 13 and a second belt 14 are mounted on one end part 11 and the other end part 12 of the sling body 10, respectively to be connected when the sling body 10 is crossed. FIG. 4 shows a state in which the first belt 13 is folded toward the second belt 14.

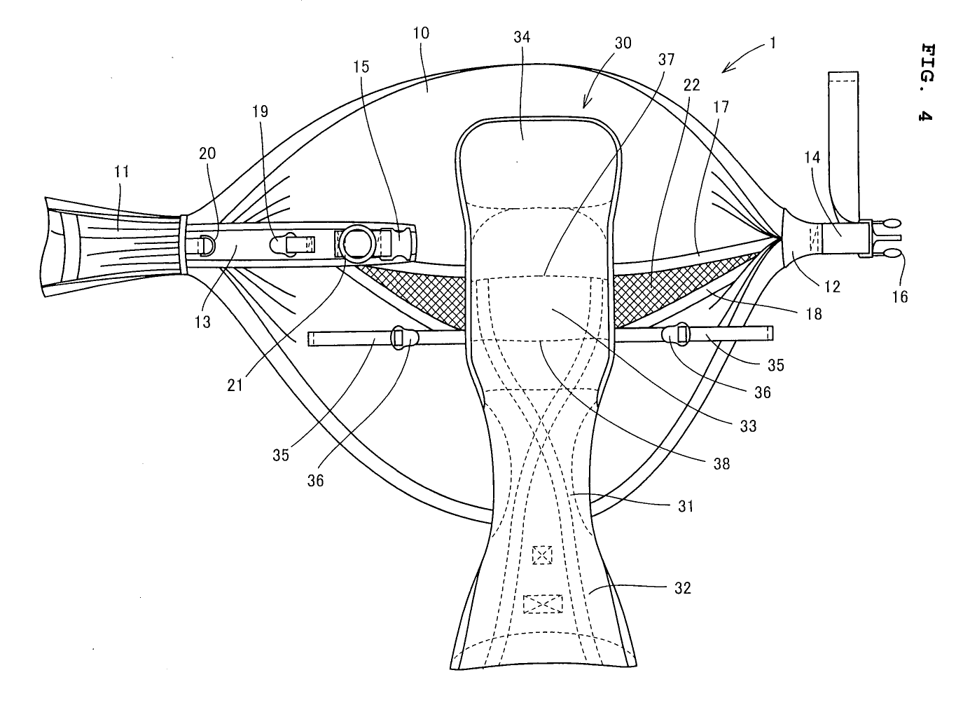

A female component 15 that is one component of a buckle member is mounted on the first belt 13 and a male component 16 that is the other component of the buckle member is mounted on the second belt 14. As shown in FIG. 5, when the male component 16 is engaged with the female component 15, one end part 11 and the other end part 12 of the sling body 10 are connected.

As shown in FIG. 4, a hook 19, a ring 20 and the charm ring 21 are mounted on the first belt 13. When the hook 19 is connected to the ring 20, the length of the first belt 13 is shortened. Therefore, according to the size of the baby or according to the way of holding the baby, the hook 19 is connected to or separated from the ring 20.

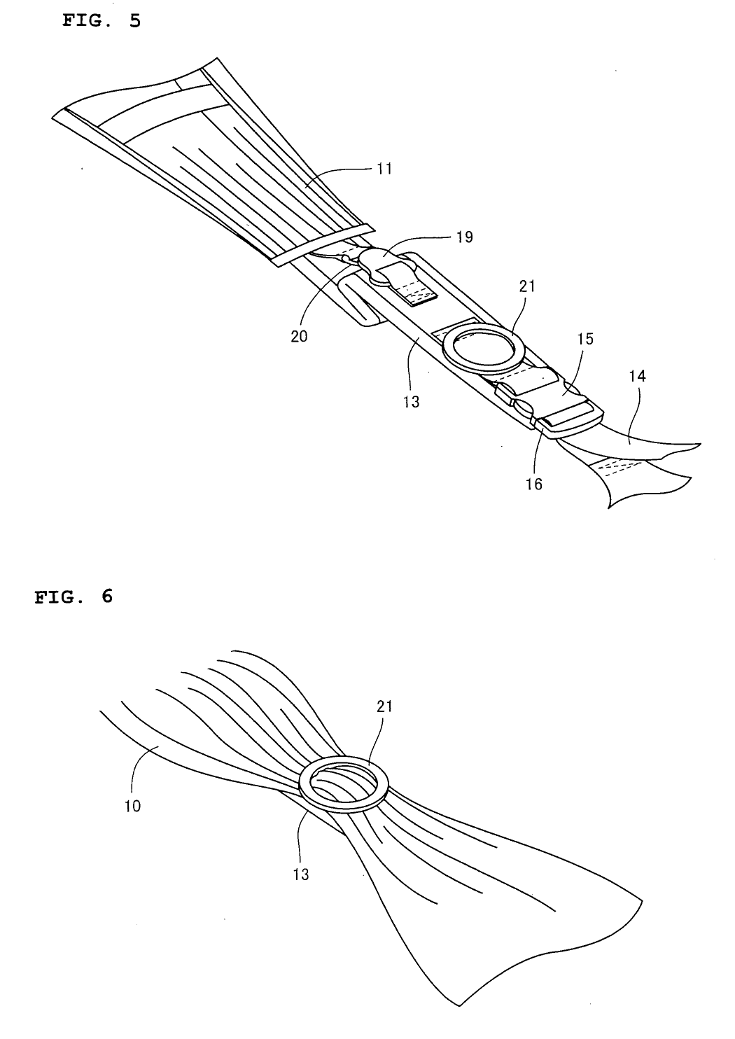

The charm ring 21 is provided for decoration. As shown in FIG. 6, when an elongated part extending from the one end part of the sling body 10 is passed through the charm ring 21, since the first belt 13, the second belt 14, the female component 15 and the male component 16 are not visible from outside, its beauty of outer appearance is improved. This can be clear from FIG. 1.

As shown in FIG. 2, a first reinforcing strap 17 and a second reinforcing strap 18 extending so as to connect the first belt 13 and the second belt 14 are sewn on the inner surface of the sling body 10. The first and second reinforcing straps 17 and 18 are provided so as to be apart from each other vertically, and the sling body part positioned between the reinforcing straps 17 and 18 is made of a mesh material 22. Therefore, the sling type baby holding carrier 1 is superior in ventilation characteristic.

As can be clear from FIG. 2, the first and second bending lines 37 and 38 of the back support pad 41 (FIG. 7) are positioned so as to overlap on the first and second reinforcing straps 17 and 18, respectively. Therefore, when the baby is held, since the back support pad 41 supported by the first and second reinforcing straps 17 and 18 from beneath is not bent, the back of the baby can be maintained in appropriate posture.

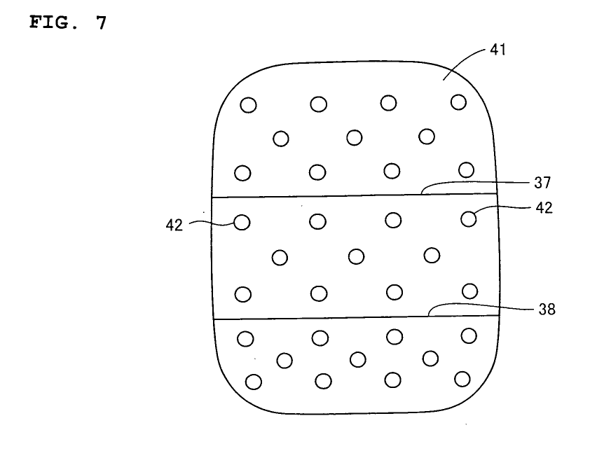

Although FIGS. 1 to 7 show the sling type baby holding carrier according to one embodiment of the present invention, various kinds of modification can be made. Several modifications will be described with reference to FIGS. 8 to 35.

According to a sling type baby holding carrier 100 shown in FIG. 8, it is intended that the sling type baby holding carrier 100 is crossed on the right shoulder of the user. In order to be more matched to that usage, according to the illustrated embodiment, a side edge 101 of a sling body with which the body of the user have contact is slightly curved inward. Thus, the volume at the sling body part with which the body of the user have contact can be reduced.

According to the embodiment shown in FIG. 8, in order to improve the ventilation characteristic, ventilation windows 102 and 103 are provided at a plurality of positions with consideration for its strength. For example, a mesh material is attached to each of the ventilation windows 102 and 103. The ventilation windows 102 are to be positioned on both sides of the head of the baby and the ventilation windows 103 are to be positioned on both sides of the body of the baby.

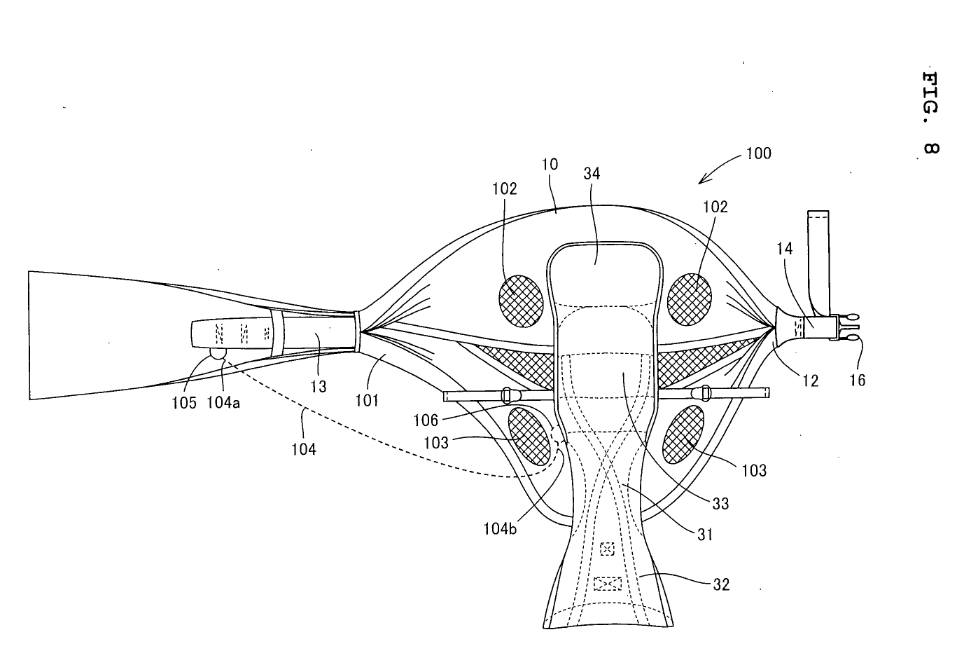

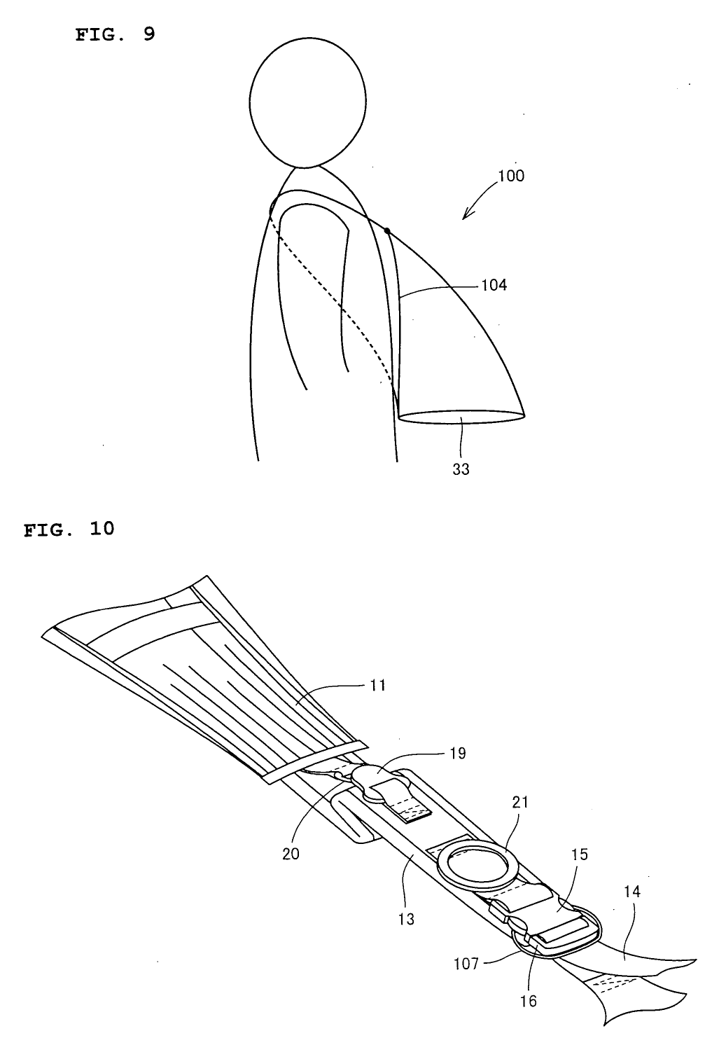

The sling type baby holding carrier 100 shown in FIG. 8 further comprises an assistive belt 104 for connecting one end of the sling body to be crossed, to the side part of a back support part or a crotch support part that is closer to that one end. More specifically, one end 104a of the assistive belt 104 is connected, so as to be removable, to an annular strap 105 mounted on the first belt 13 mounted on one end part of the sling body, and the other end 104b thereof is connected, so as to be removable, to an annular strap 106 mounted on the outer surface of the sling body positioned on the back surface of the back support part 33 or the crotch support part 31. As shown in FIG. 9, the assistive belt 104 allows the back support part 33 to be stably held in the horizontal state when the sling type baby holding carrier 100 is used for holding the baby laterally.

According to an embodiment shown in FIG. 10, an annular member 107 is mounted on the first belt 13 in order to avoid a risk that the connection between the female component 15 mounted on the first belt 13 and the male component 16 mounted on the second belt 14 is disconnected unexpectedly. When this annular member 107 is positioned so as to engage with the male component 16, since the connected state between the first belt 13 and the second belt 14 is maintained even when the connection between the female component 15 and the male component 16 is unexpectedly disconnected, it is preferable in view of safety.

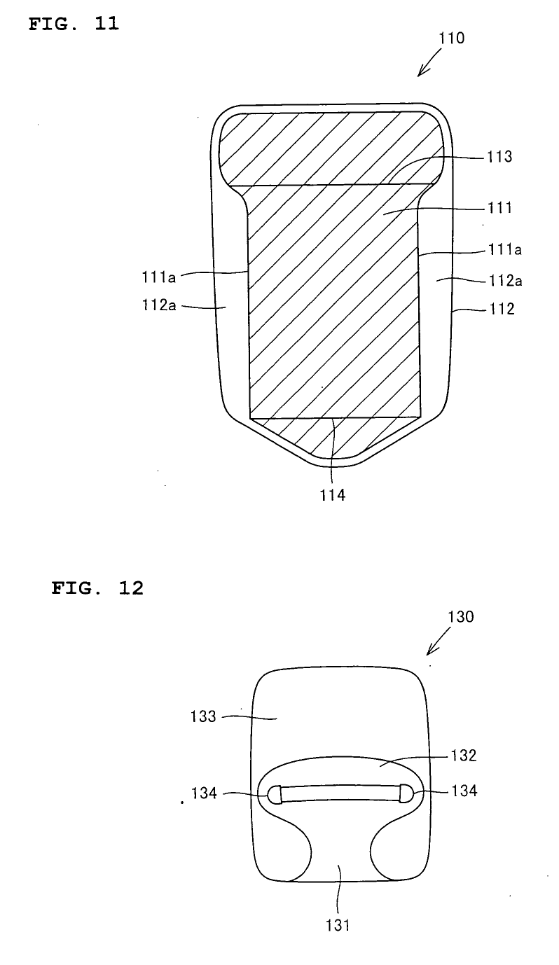

FIG. 11 shows another example of a back support pad. An illustrated back support pad 110 comprises a relatively rigid core part 111, and a cover part 112 made of a flexible material covering the core part 111. The core part 111 comprises a first bending line 113 and a second bending line 114 extending in the width direction. As shown in FIG. 11, the core part 111 comprises an upper region having a predetermined width dimension, and a lower region positioned under the upper region and having a width smaller than that of the upper region. Both side edges 111a of the lower region of the core part 111 retreats inward such that the width becomes small, so that a cover part 112a positioned at this part forms a relatively wide strap part. When a small baby is held laterally, the wide strap part 112a of the cover part 112 is bent upward from the core part 111. After the baby has been grown up and the body has become big, the back of the baby is positioned on the wide strap part 112a of the cover part 112. According to the back support pad 110 shown in FIG. 11, since its configuration is changed according to the size of the baby, the baby can be appropriately held on it.

FIG. 12 shows another example of a baby restraint member mounted on the inner surface of the sling body. A baby restraint member 130 shown in FIG. 12 comprises a back support part 133 having bending rigidity, a crotch support part 131 continuously extending from the back support part 133, and an abdomen support part 132 continuously extending from the crotch support part 131. This embodiment is characterized by the configuration of the abdomen support part 132. That is, the abdomen support part 132 largely expands from the boundary with the crotch support part 131 toward both sides. Connecting rings 134 caught by the hooks of the connecting member (hook 36 shown in FIGS. 2 to 4) that is not shown are positioned at both sides of the expanding abdomen support part 132. Therefore, a fitment and the like used at the connecting point will not come into contact with the thigh of the baby.

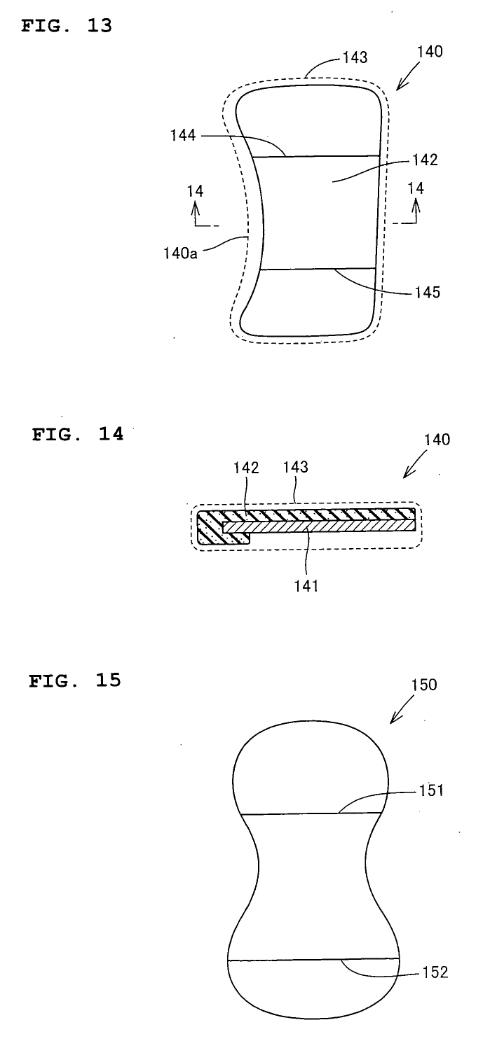

FIGS. 13 and 14 show other examples of a back support pad contained in the back support part on the inner surface of the sling body. A back support pad 140 having bending rigidity comprises a back support core member 141 having bending rigidity, a soft cushion member 142 positioned on that, and a cover member 143 covering those. As shown in FIG. 13, a side edge part 140a of the back support pad 140 to be positioned on the side of the body of the user is curved inward so as to follow the body of the user. Although all of the back support core member 141, the cushion member 142 and the cover member 143 are curved inward in the illustrated embodiment, as another embodiment, only the back support core member 141 may have a side edge curved inward and the soft cushion member 142 and the cover member 143 may have not curved but linear side edges.

Similar to the above embodiment, the back support pad 140 has bending lines 144 and 145 extending in the width direction so that the sling type baby holding carrier can be folded compactly along the bending lines. Preferably, reinforcing straps extending so as to cross the back support part are sewn on the inner surface of the sling body, and the bending lines 144 and 145 of the back support pad 140 are positioned so as to overlap on the reinforcing strap.

As shown in FIG. 14, the soft cushion member 142 is wound around the side edge of the inwardly curved back support core member 141 and reaches the back surface of the back support core member. Thus, the user can feel the touch of the soft cushion member 142.

FIGS. 15 and 16 show other embodiments of a back support pad. In case of a newborn baby, the arms are folded in the shape of “W” and the legs are folded in the shape of “M”. When the above posture is pressed from the side, the baby feels uncomfortable and hip dislocation is caused in an extreme case. Thus, each of back support pads 150 and 153 has an upper region having an inverted trapezoid shape and a lower region having a trapezoid shape.

More specifically, the back support pad 150 shown in FIG. 15 has bending rigidity and both sides of a center region are curved inward. The upper region has a wide and smooth curved outline. Similarly, the lower region has a wide and smooth curved outline. Furthermore, the back support pad 150 has bending lines 151 and 152 extending in the width direction. Preferably, reinforcing straps sewn on the sling body extend so as to overlap on the bending lines 151 and 152.

The back support pad 153 shown in FIG. 16 has bending rigidity and has an upper region having an inverted-trapezoidal shape, a middle region having a rectangular shape, and a lower region having a trapezoidal shape. Furthermore, the back support pad 153 has bending lines 154 and 155 extending in the width direction. Preferably, reinforcing straps sewn on the sling body extend so as to overlap on the bending lines 154 and 155.

Similar to the back support pad 140 shown in FIGS. 13 and 14, each of the back support pad 150 and 153 may have a back support core member having bending rigidity, and a soft cushion member arranged thereon.

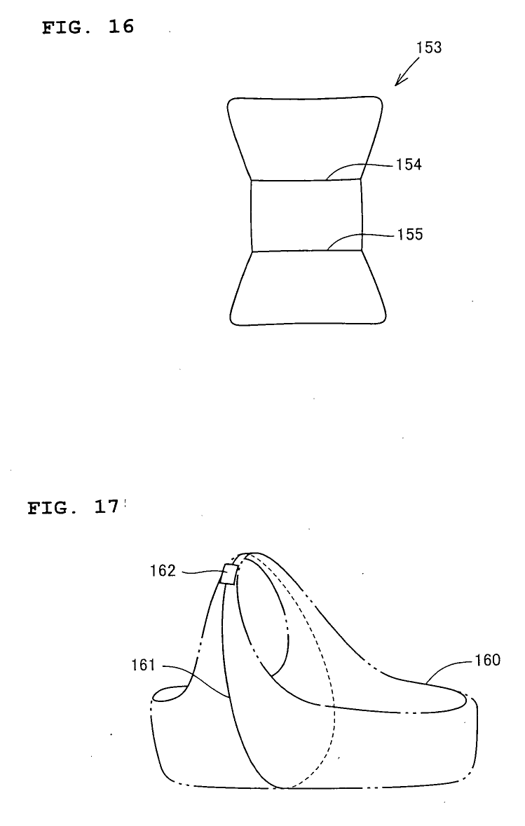

One of the characteristics of the sling type baby holding carrier according to the embodiment of the present invention lies in that the sling type baby holding carrier comprises the load supporting reinforcing strap. A sling type baby holding carrier schematically shown in FIG. 17 comprises a cloth sling body 160 that can be crossed, and a load supporting reinforcing strap 161 mounted on the sling body 160 so as to extend over a region in which the baby enveloped in the sling body is supported from beneath. The load supporting reinforcing strap 161 takes a shape of a loop strap extending in the shape of a loop in which one end is connected to the other end of the sling body 160 when crossed. A buckle 162 connecting both ends of the reinforcing strap 161 so as to be removable is mounted on a middle position of the load supporting reinforcing strap 161. The load supporting reinforcing strap 161 that supports the load of the baby from beneath stably hold the baby enveloped in the sling body 160.

In addition, according to the embodiment shown in FIG. 2, the first reinforcing strap 17 and the first belt 13 and the second belt 14 form the looped load supporting reinforcing strap.

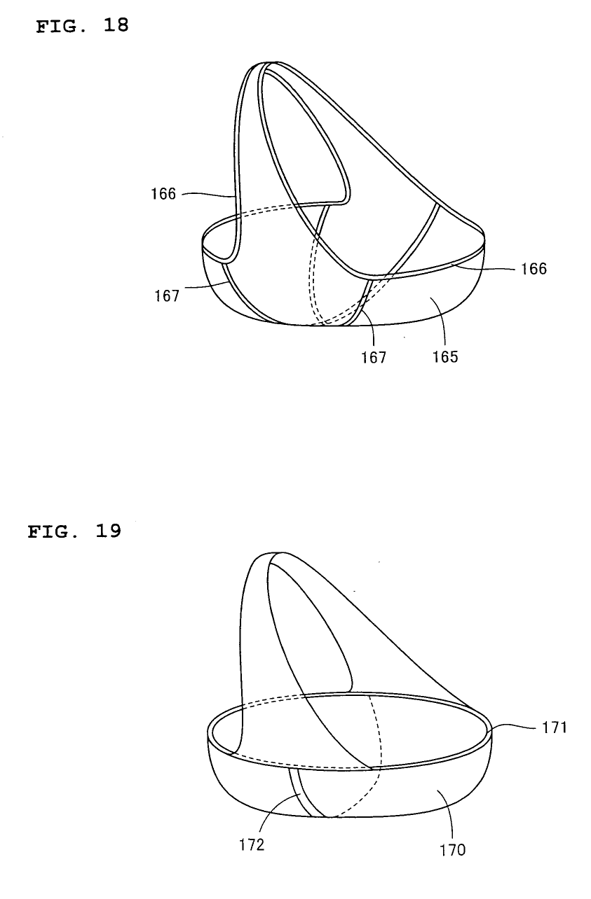

FIG. 18 schematically shows a sling type baby holding carrier according to another embodiment. The sling type baby holding carrier shown in FIG. 18 comprises a sling body 165, a reinforced edge part 166 for reinforcing the edge part of the sling body 165, and a load supporting strap 167 having both ends connected to the reinforced edge part 166.

FIG. 19 schematically shows a sling type baby holding carrier according to still another embodiment. The illustrated sling type baby holding carrier comprises a sling body 170, a reinforced edge part 171 and a load supporting reinforcing strap 172 similar to the embodiment shown in FIG. 18. According to this embodiment, the reinforced edge part 171 reinforces a main edge part of the sling body 170 and extends annularly so as to surround the upper part of the region in which the baby is put. Both ends of the load supporting reinforcing strap 172 are connected to the annularly extending reinforce edge part 171.

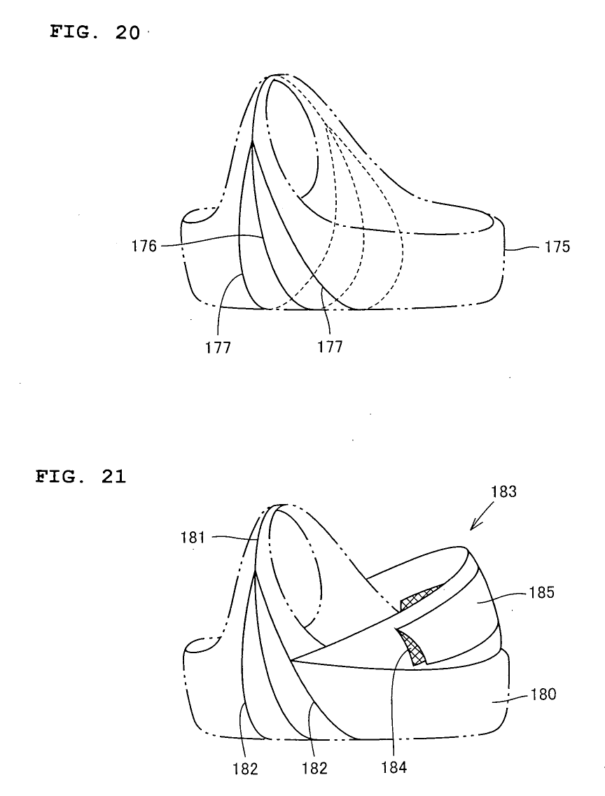

FIG. 20 schematically shows a sling type baby holding carrier according to still another embodiment. The illustrated sling type baby holding carrier comprises a sling body 175, a loop strap part 176 extending in the form of a loop in which one end of the sling body 175 is connected to the other end when crossed, and branching strap parts 177 branching from the loop strap part 176 and extending over the region in which the baby is supported from beneath. The loop strap part 176 and the branching strap parts 177 serve as the load supporting reinforcing strap.

FIG. 21 schematically shows a sling type baby holding carrier comprising a hood. The illustrated sling type baby holding carrier preferably comprises the characteristic constitution described above.

The sling type baby holding carrier shown in FIG. 21 comprises a cloth sling body 180 that can be crossed, and a hood 183 mounted on the sling body 180 so as to cover the upper region of the head of the baby enveloped in the sling body 180. A loop strap part 181 and branching strap parts 182 serving as the load supporting reinforcing strap are sewn on the sling body 180. The loop strap part 181 extends in the form of a loop in which one end of the sling body 180 is connected to the other end when crossed, and the branching strap parts 182 branch from the loop strap 181 and extend over the region in which the baby is supported from beneath.

The hood 183 preferably in the form of an arch and its both ends are connected to the load supporting reinforcing strap. According to the illustrated embodiment, both ends of the hood 183 are connected to the branching strap parts 182. When both ends of the hood 183 are connected to the load supporting reinforcing strap, the configuration of the hood 183 can be stably maintained.

The arch-shaped cover 183 comprises a window 184 and a cover 185 for opening and closing the window 184. A mesh cloth may be attached to the window 184. The hood 183 has a function to adjust brightness in the baby space in addition to a function as a blind. In order to increase the brightness, the hood is folded to largely open the upper part of the baby space. In order to darken the baby space, the hood is exploded into the arch shape to partially close the upper region of the baby space.

Since the hood 183 comprises the window 184 and the cover 185, the brightness in the baby space can be adjusted in stages.

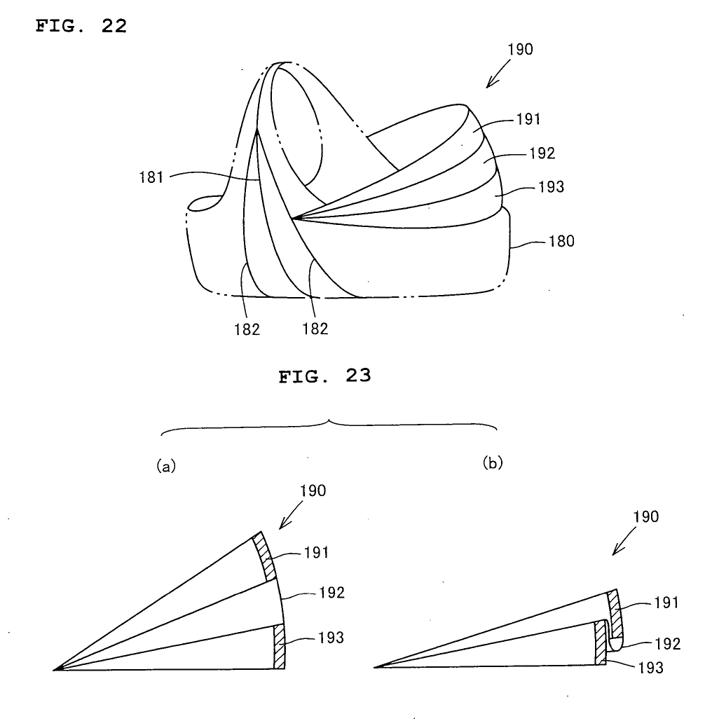

A sling type baby holding carrier schematically shown in FIG. 22 comprises a sling body 180, a loop strap part 181, branching strap parts 182, and a hood 190. The hood 190 has an arch shape and its both ends are connected to the branching strap parts 182 serving as the load supporting reinforcing strap.

The hood 190 will be described in detail with reference to FIG. 23. The hood 190 comprises an arch-like first hood 191 made of a relatively rigid material and extending in the width direction, an arch-like second hood 192 made of a relatively flexible material and extending in the width direction so as to be positioned adjacent to the first hood 191, and an arch-like third hood 193 made of a relatively rigid material and extending in the width direction so as to be positioned adjacent to the second hood 192. The thickness of the second hood 192 is smaller than those of the first and third hoods 191 and 193.

FIG. 23(a) shows the hood 190 in its exploded state, and FIG. 23(b) shows the hood 190 in its folded state. According to the folded state of the hood 190, the first and third hoods 191 and 193 overlap with each other. The flexible second hood 192 is sandwiched between the overlapping first and third hoods 191 and 193. According to this embodiment, since the hood 192 made of the flexible material is positioned between the two hoods 191 and 193 made of the rigid material, the hood 190 can be folded compactly, and its folded state can be stably maintained.

Although the hood 190 shown in FIG. 23 can be used as the hood of the sling type baby holding carrier, it can be used in another child-care instrument. For example, it can be used in a child-care instrument having a space for receiving a baby such as a baby carriage, a child safety seat in a car, a child chair in a room, a bed and the like.

It is said that the focal point of the 6-month-old baby is 25 to 30 cm. Therefore, when the distance between a parent face and the baby face is about 25 to 30 cm, the baby can recognize the parent face. In order to foster the affection between the parent and child, the distance between the parent eyes and the baby eyes is preferably 25 to 30 cm. Thus, in the case of the sling type baby holding carrier comprising the hood, the distance between the top of the hood and the baby face is preferably set to 25 to 30 cm. In the case of the baby holding carrier having such dimension, when the parent brings the face close to the top of the hood to see the face of the baby, the baby can recognize the parent face. Thus, an eye-to-eye relation between the parent and the baby can be implemented. When a line or a design for implementing the above eye-to-eye relation is provided on the outer surface of the baby holding carrier and the hood, the user can recognize the appropriate distance to implement the eye-to-eye relation, and willingly bring the face to the position to the distance (the position of the hood top), so that the affection between the parent and the baby can be fostered more.

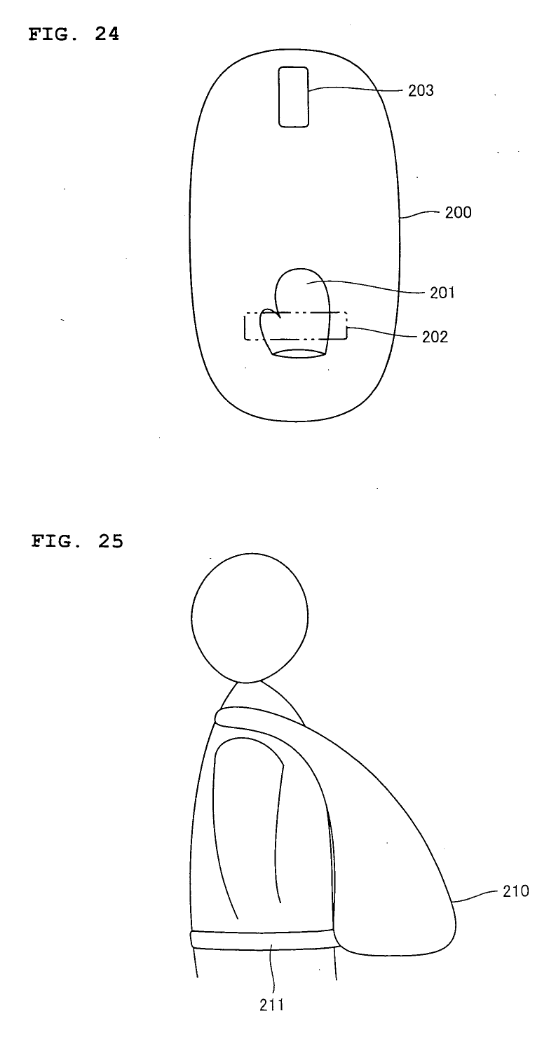

FIG. 24 schematically shows an embodiment that is devised such that a mother or a father who uses the sling type baby holding carrier can easily support the baby. An illustrated sling type baby holding carrier comprises a cloth sling body 200 for enveloping and holding the body of the baby in its crossed state on the shoulder of a user, hand receiving members 201 and 203 having receiving parts to which the hand of the user is inserted and provided on the outer surface of the sling body 200. The hand receiving member 201 is positioned so as to support the buttocks of the baby from beneath. The hand receiving member 203 is positioned so as to support the back of the baby.

The hand receiving member may have any configuration as long as it can receive the hand of the user. According to the illustrated embodiment, the hand receiving member 201 positioned so as to support the buttocks of the baby has a configuration of a mitten. When the hand receiving member 201 is formed like the mitten as shown in FIG. 24, the hand can be easily inserted. The other hand receiving member 203 positioned so as to support the back of the baby has a configuration of a belt so that the user can insert the hand from the side.

The user inserts the right hand to the mitten-shaped hand receiving member 201 to support the buttocks of the baby from beneath and inserts the left hand to the belt-shaped hand receiving member 203 to support the back of the baby, for example. The mitten-shaped hand receiving member 201 may be uncomfortable in a hot season. Therefore, a belt-shaped hand receiving member 202 may be provided so as to overlap on the mitten-shaped hand receiving member 201. In this way, the user can insert the hand between the mitten 201 and the belt 202 in the hot season.

The sling type baby holding carrier is crossed on the shoulder of the user when used. At this time, the sling type baby holding carrier is preferably closely in contact with the body of the user in view of safety in some cases. According to embodiments shown in FIGS. 25 to 27, a connecting member for connecting the sling body to the waist of the user is provided.

More specifically, a sling type baby holding carrier shown in FIG. 25 comprises a cloth sling body 210 for enveloping and holding the body of the baby in its crossed state on the shoulder of the user, and a connecting member 211 for connecting the sling body 210 to the hip of the user. The connecting member 211 is a hip belt or a hip strap to be wound around the hip of the user and it is mounted on the outer surface of the sling body 210 positioned at a region close to the hip of the user.

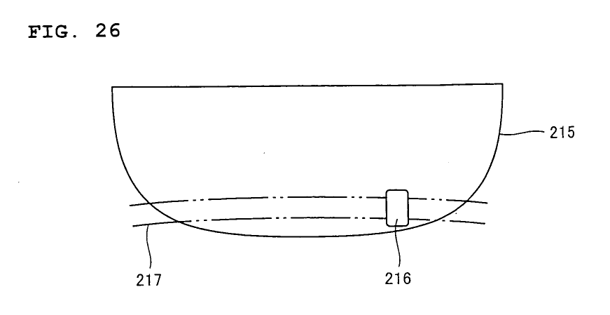

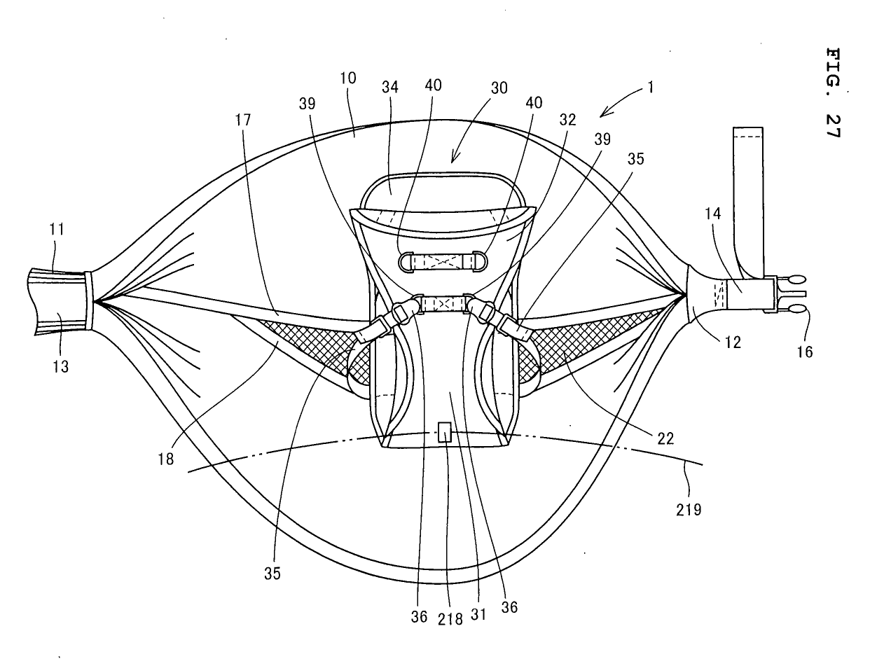

A sling type baby holding carrier schematically shown in FIG. 26 comprises a loop-shaped member 216 serving as a connecting member mounted on the outer surface of a sling body 215 positioned at a region close to the hip of the user. For example, by passing a belt 217 of pants of the user through the loop-shaped member 216, the sling body 215 can be closely attached to the hip of the user. In addition, in FIG. 26, the sling type baby holding carrier that is used for holding the baby in the lateral direction is shown. In order to use the loop-shaped member 216 in the vertical direction, the loop-shaped member 216 may be turnably mounted on the sling body 215.

Although one connecting member may be turned so as to correspond to the cases where the baby is held in the lateral direction and vertical direction as described above, one connecting member may be used when the baby is held in the lateral direction and the other connecting member may be used when the baby is held in the vertical direction as another embodiment.

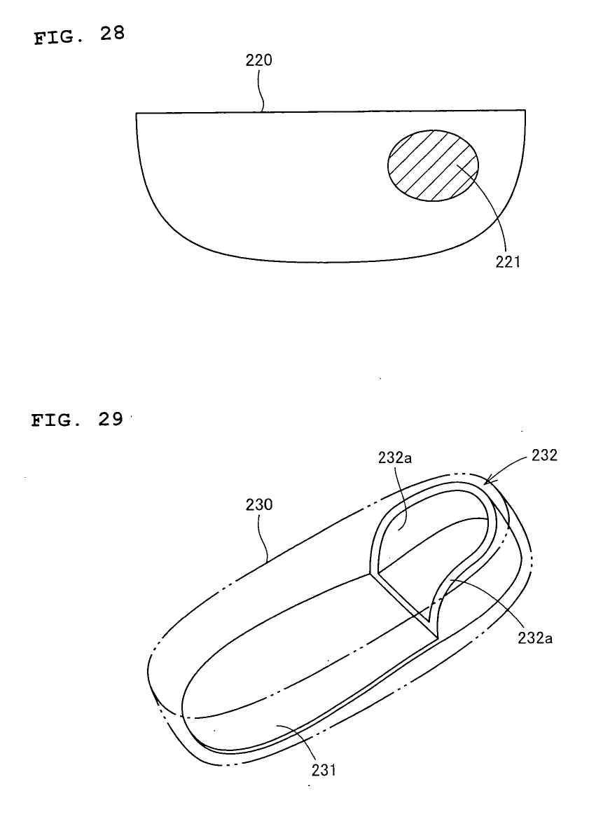

FIG. 27 shows an example in which a connecting member 218 for holding the baby in the vertical direction is added to the embodiment shown in FIG. 3. The connecting member 218 for holding the baby in the vertical direction is a loop-shaped member or a belt-shaped member through which a belt 219 of pants is passed, and mounted on the back surface of the crotch support part 31.

In order to protect the baby enveloped in the sling body from noise, a soundproof member may be mounted on the sling body. A sling type baby holding carrier schematically shown in FIG. 28 comprises a cloth sling body 220 that can be crossed, and soundproof members 221 arranged on the inner surface of the sling body 220 so as to be positioned close to both ears of the baby enveloped in the sling body 220. The soundproof member 221 may be fixed to the sling body 220 or detachably mounted thereto.

FIG. 29 shows another example of a sling type baby holding carrier comprising a soundproof member. The sling type baby holding carrier shown in FIG. 29 comprises a sling body 230, a head pad 232 arranged on the inner surface of the sling body 230 to protect the head of the baby, and a back support part 231 having bending rigidity and arranged on the inner surface of the sling body 230 so as to support the back of the baby. The head pad 232 has a rising wall 232a at a position close to both sides of the head of the baby and this rising wall 232a contains a soundproof member. In addition, the head pad 232 may comprise a pillow (not shown) having a recessed part in which the back of the head of the baby is set or a projection for supporting the neck of the baby from behind.

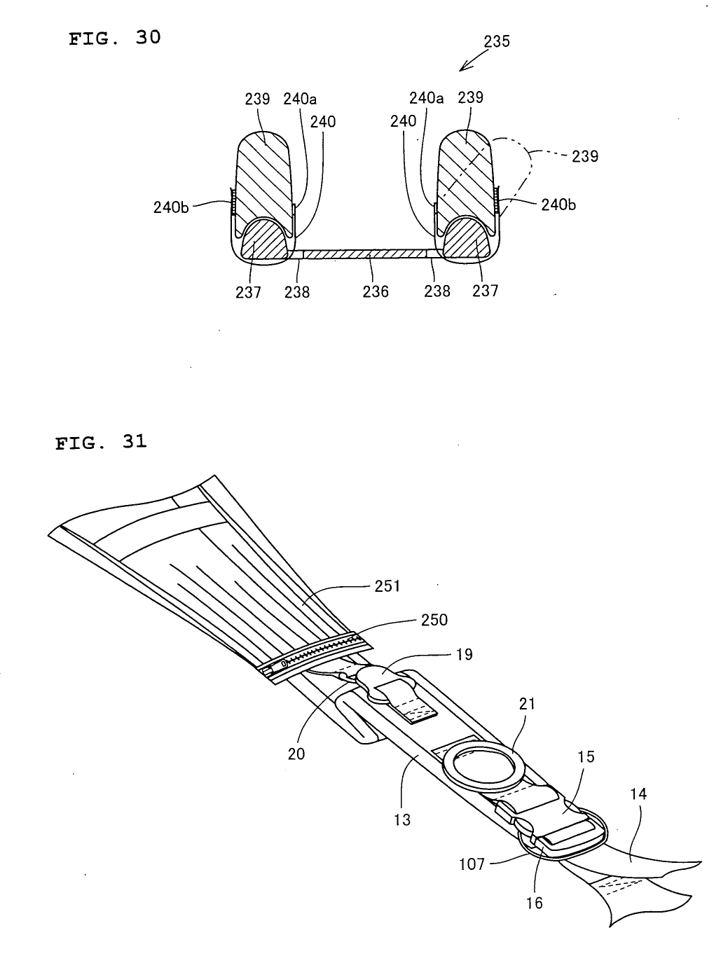

FIG. 30 shows a head pad 235 comprising a soundproof member as another example. The head pad 235 comprises a pillow 236 having mountain parts 237 having a shape of a semicircle in section at each side, and a pair of rising walls 239 to be positioned close to both sides of the head of the baby. The rising wall 239 contains a soundproof member. The bottom surface of the rising wall 239 is recessed so as to have a shape of a semicircle in section and positioned on the mountain part 237. Each rising wall 239 and the mountain part are connected by a connecting belt 240. More specifically, one end 240a of the connecting belt 240 is fixed to the inner side surface of the rising wall 239 and the other end 240b thereof is passed through a hole 238 of the pillow 236 and the lower part of the mountain part 237 and detachably connected to the outer side surface of the rising wall 239 through a surface fastener. According to the head pad 235, as shown in a phantom line in FIG. 30, the rising angle of the rising wall 239 can be changed. Therefore, both sides of the baby can be open or closed according to need.

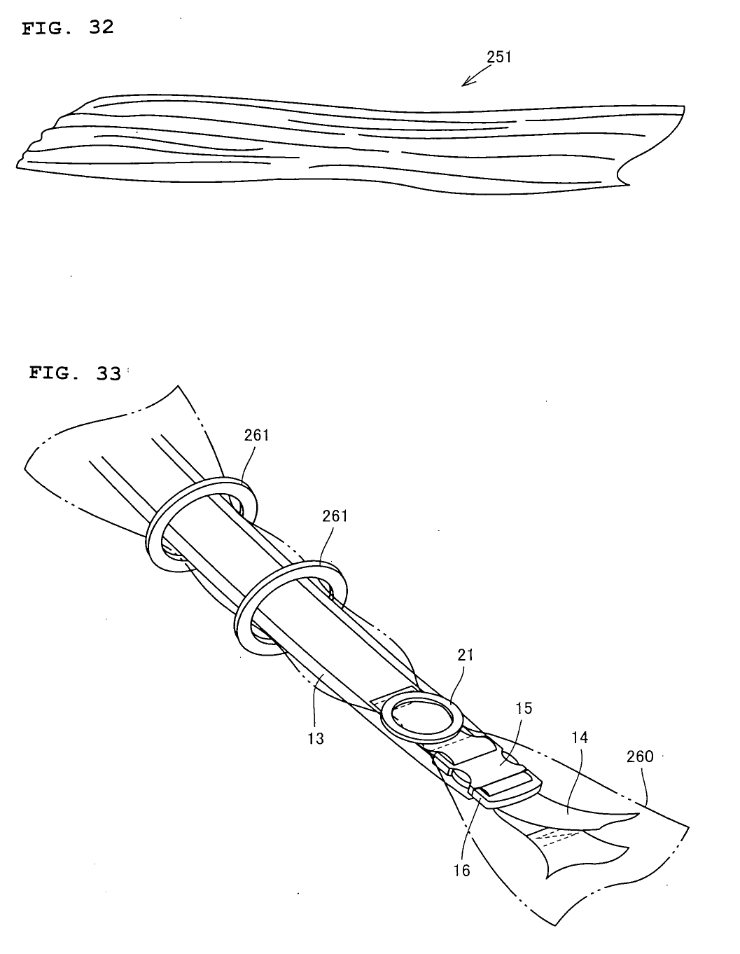

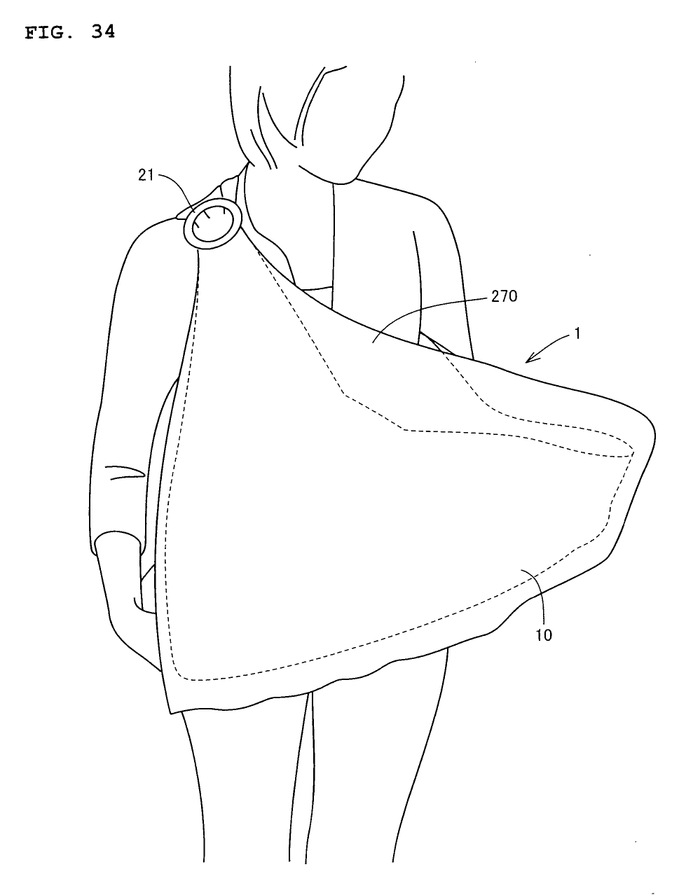

The sling type baby holding carrier according to the embodiment shown in FIG. 10 comprises the cloth sling body that can be crossed and the buckle member for connecting one end part and the other end part of the sling body detachably. FIG. 31 shows an embodiment that is slightly varied from the embodiment shown in FIG. 10. More specifically, a sling type baby holding carrier in this embodiment comprises a charm member 251 extending so as to cover the buckle member and detachably connected to one end part of the sling body through a slide fastener 250, for example. When various kinds of charm members 251 having different designs are prepared, the user can enjoy a variation in design by appropriately selecting one of them. FIG. 32 shows the charm member 251 removed from the sling body, which can be used as a scarf.

As described above, since the charm member 251 is provided so as to be detachable from the sling body, even when the sling type baby holding carrier becomes unnecessary after the baby has been grown up, it can be stored as memory goods for maintaining the memory of the babyhood.

FIG. 33 shows another structure for retaining the detachable charm member. The belts 13 and 14 having the buckles 15 and 16 are mounted on one end part and the other end part of the sling body to be crossed, respectively. The charm ring 21 through which a charm member 260 is passed is mounted on the belt 13. According to this embodiment, the charm member 260 is detachably connected to the sling body through the charm ring 21. In order to stably hold the upper part of the charm member 260, a ring 261 through which the charm member 260 is passed is mounted on the belt 13.

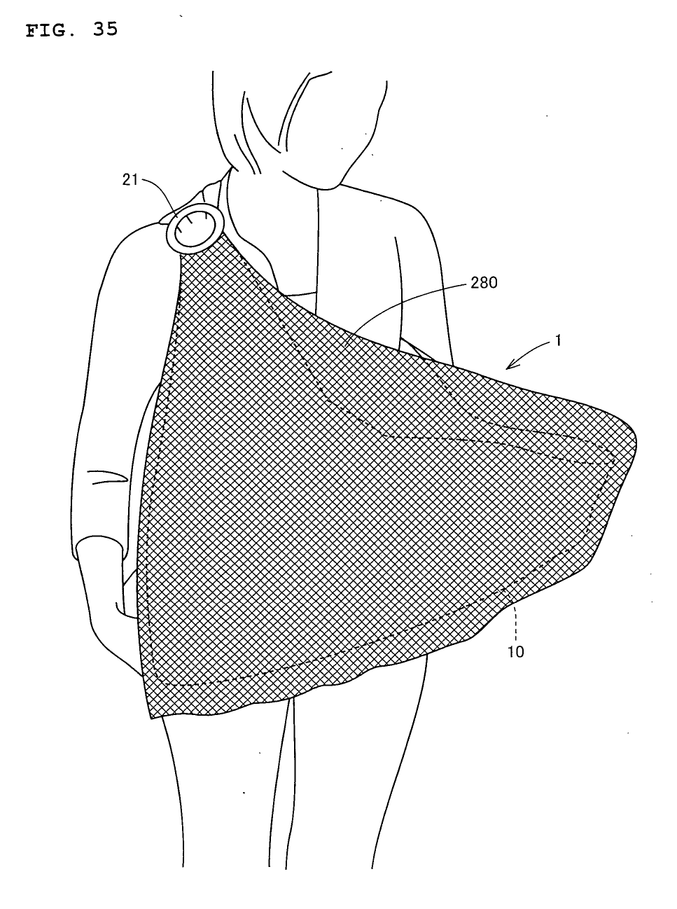

FIGS. 34 and 35 show detachable charm members as another example. Charm members 270 and 280 shown in FIGS. 34 and 35 have configurations that can cover the upper space of the baby enveloped in the sling body. The charm member 270 shown in FIG. 34 has a configuration that can be used as a rain cover, and the charm member 280 shown in FIG. 35 has a configuration that can be used as a mosquito net.

FIG. 36 shows an embodiment to which a slight modification is added to the embodiment shown in FIG. 10. According to this embodiment, a sling type baby holding carrier comprises a soft shoulder pad 300 positioned under the buckle member. More specifically, the shoulder pad 300 has a width larger than that of the first belt 13 and mounted on the back surface of the first belt 13. The shoulder pad 300 may be fixed to the first belt or may be detachably mounted thereon through a surface fastener and the like. Since the soft shoulder pad 300 according to this embodiment can prevent the buckle member and the belts 13 and 14 from being directly in contact with the neck and shoulder of the user, the nursery strap is comfortable and friendly for the user.

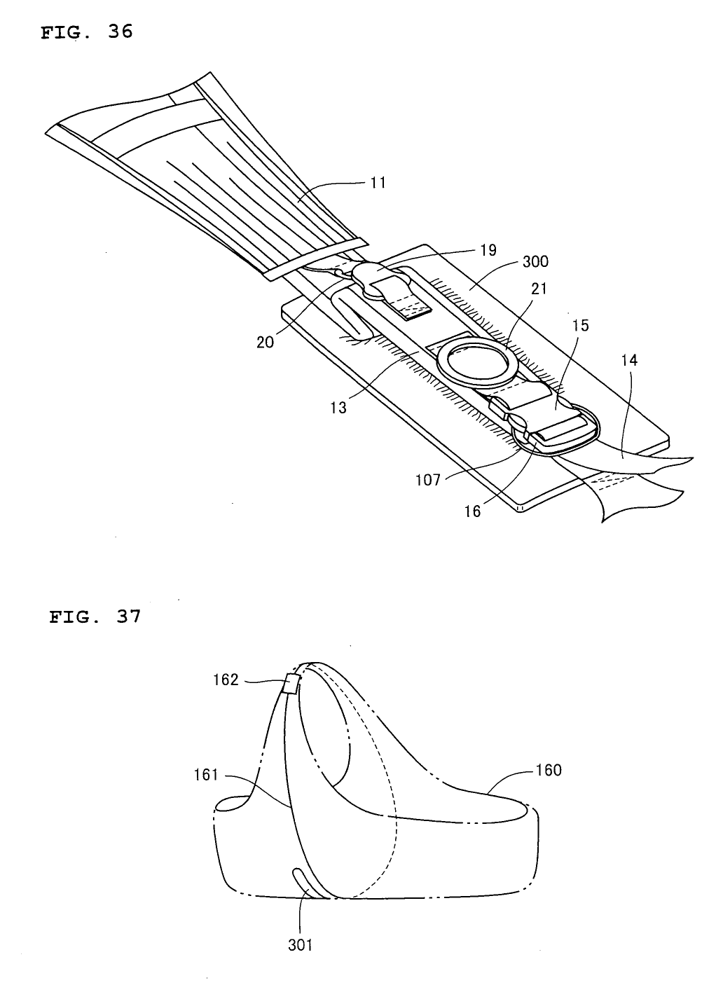

FIG. 37 shows an embodiment to which a slight modification is added to the embodiment shown in FIG. 17. A sling type baby holding carrier according to this embodiment comprises a cloth sling body 160 enveloping and holding the body of the baby in a crossed state on the shoulder of the user. A slit 301 through which the user can insert the hand into the inside is provided in the sling body 160. The user can insert the hand into the inside of the sling body 160 from this slit 301 and touch the baby directly and feel the warmth of the baby, the user can hold the baby with a safe conscience. Thus, the slit 301 can be used for increasing physical affection between the parent and the baby.

Preferably, the sling body 160 comprises a load supporting reinforcing strap 161 mounted on the sling body so as to extend over the region in which the baby enveloped in the sling body is supported from beneath. To prevent the strength of the sling body 160 from being lowered due to the slit 301, it is preferable to provide the slit 301 along the reinforcing strap 161.

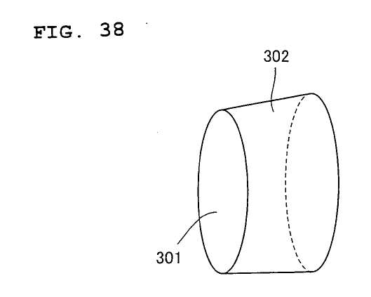

Further preferably, in order to prevent a draft from coming into the sling body 160 through the slit 301, a cloth cylindrical member 302 shown in FIG. 38 is mounted on the inner surface of the sling body 160. The cylindrical member 302 has a configuration to surround the opening edge of the slit 301. The user can insert the hand into the sling body 160 through the cylindrical member 302.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

What is claimed is:

1. A sling type baby holding carrier comprising:
a cloth sling body that can be crossed;
a crotch support part fixed to the inner surface of said sling body so as to support the crotch of a baby;
an abdomen support part continuously extending from said crotch support part so as to support the abdomen of the baby; and
a connecting member for connecting said sling body to said abdomen support part.

2. The sling type baby holding carrier according to claim 1, further comprising a back support part arranged on the inner surface of the sling body so as to support the back of the baby.

3. The sling type baby holding carrier according to claim 2, wherein a back support pad is contained in said back support part.

4. The sling type baby holding carrier according to claim 3, wherein said back support pad is contained in the back support part so as to be removable.

5. The sling type baby holding carrier according to claim 1, wherein a buckle member for detachably connecting one end part to the other end part of said sling body to be crossed is mounted on each end.

6. The sling type baby holding carrier according to claim 5, wherein a belt retaining said buckle member is mounted on each of the one end part and the other end part of the sling body to be crossed, and
a reinforcing strap extending so as to connect said belt at the one end part to said belt at the other end part is sewn on the inner surface of said sling body.

7. The sling type baby holding carrier according to claim 6, comprising a back support pad held on the inner surface of said sling body so as to support the back of the baby, wherein
said back support pad has a bending line extending in a width direction and can be bent along the bending line, and
the bending line of said back support pad is positioned so as to overlap on said reinforcing strap.

8. The sling type baby holding carrier according to claim 6, wherein said reinforcing strap comprises a first reinforcing strap and a second reinforcing strap extending with a space in a vertical direction, and
a part positioned between said first reinforcing strap and said second reinforcing strap in said sling body is made of a mesh material.

9. The sling type baby holding carrier according to claim 5, wherein a belt retaining said buckle member is mounted on each of one end part and the other end part of the sling body to be crossed, and
a charm ring through which a part of the sling body is passed is mounted on said one end part.

10. The sling type baby holding carrier according to claim 2, further comprising a head guard part connected to the upper end of said back support part such that it can be bent.

11. The sling type baby holding carrier according to claim 2, further comprising an assistive belt for connecting one end part of said sling body to be crossed to the side part of said back support part or crotch support part that is closer to that end part.

12. The sling type baby holding carrier according to claim 1, wherein a ventilation window is provided in said sling body.

13. The sling type baby holding carrier according to claim 1, wherein said abdomen support part has a configuration largely expanding from a boundary with said crotch support part toward both sides, and
said connecting members are connected to both side ends of the largely expanding abdomen support part.

14. The sling type baby holding carrier according to claim 1, wherein each of said crotch support part and said abdomen support part comprises an elastic material.

15. The sling type baby holding carrier according to claim 14, wherein each of said crotch support part and said abdomen support part comprises a pad having restoring force to return to a plane configuration.
